(19) United States
(12) Patent Application Publication
(10) Pub. No.: US 2025/0346512 A1
(43) Pub. Date: Nov. 13, 2025

(54) WATER TREATMENT METHOD, WATER TREATMENT APPARATUS, SLIME INHIBITOR, AND CLEANING METHOD

(71) Applicant: ORGANO CORPORATION, Tokyo (JP)

(72) Inventors: Mitsuya MORI, Tokyo (JP); Shohei YAMAMOTO, Tokyo (JP); Nau KIDA, Tokyo (JP); Keisuke SASAKI, Tokyo (JP); Hiro YOSHIKAWA, Tokyo (JP)

(73) Assignee: ORGANO CORPORATION, Tokyo (JP)

(21) Appl. No.: 18/874,253

(22) PCT Filed: Apr. 28, 2023
(86) PCT No.: PCT/JP2023/016864

§ 371 Date: Dec. 12, 2024

(30) Foreign Application Priority Data
Jun. 16, 2022 (JP) 2022-096973

(51) Int. Cl. C02F 1/76; B01D 61/48; B01D 61/58; B01D 65/02; C02F 1/44; C02F 1/469; C02F 9/00

(52) U.S. Cl. CPC C02F 1/766; B01D 61/48; B01D 61/58; C02F 1/4695; C02F 9/00; B01D 65/02; B01D 2311/04; B01D 2321/168; C02F 1/44; C02F 2303/16; C02F 2303/20

(57) ABSTRACT

A water treatment method includes: adding a chemical to water to be treated to obtain water to be treated which contains iodine and is provided with oxidizing power; and supplying the water to be treated that has undergone the chemical addition to an electrodeionization device (EDI device) to treat the water to be treated in the EDI device. At least a part of an ion exchanger filled in a deionization chamber of the EDI device is an anion exchanger.

### TECHNICAL FIELD

The present invention relates to a water treatment method and a water treatment apparatus using an electrodeionization device, a slime inhibitor used in the electrodeionization device, and a method for cleaning the electrodeionization device.

### BACKGROUND ART

As one of devices for generating deionized water from water to be treated, there is an electrodeionization device (also referred to as an EDI device). The EDI device is a device in which electrophoresis and electrodialysis are combined, and has a configuration in which a deionization chamber partitioned by a pair of ion exchange membranes is disposed between an anode and a cathode. In the EDI device, at least the deionization chamber is filled with an ion exchanger such as an ion exchange resin, and, by applying a DC voltage between the anode and the cathode while passing the water to be treated through the deionization chamber, treated water from which ion components have been removed flows out from the deionization chamber and the regeneration process of the ion exchanger in the deionization chamber proceeds. The EDI device has an advantage that it does not require a process of regenerating the ion exchanger by a chemical. In the EDI device, a concentration chamber is adjacent to the deionization chamber across an ion exchange membrane that partitions the deionization chamber. In the concentration chamber, the ion concentration is easily increased by the ion components moved from the deionization chamber, and slime derived from viable bacteria is likely to occur. For example, as described in Patent Literature 1, when slime is generated, the flow of water is suppressed, so that the differential pressure of water passing tends to rise.

In general, in order to suppress the occurrence of slime in a water treatment apparatus, there is a method of adding a slime inhibitor, which is also referred to as a slime control agent, to water supplied to the apparatus. The slime inhibitor is composed of, for example, hypochlorous acid, hydrogen peroxide, ozone, or the like which have a bactericidal action. However, hypochlorous acid, hydrogen peroxide, ozone, and the like are oxidizing agents, and when these oxidizing agents flow into an EDI device, the ion exchange resin and the ion exchange membrane constituting the EDI device are deteriorated as described in Patent Literatures 1 and 2, and the rapid lowering of water quality in the treated water and the rise of the differential pressure of water passing in the concentration chamber and the deionization chamber may occur. Patent Literature 1 discloses that since the deterioration of an EDI device by an oxidizing agent progresses fast when a DC current is applied between the anode and the cathode of the EDI device, the voltage application between the anode and the cathode is stopped or weakened when the water containing an oxidizing bactericide is made to flow to the EDI device for slime removal. Patent Literature 3 discloses that, when the differential pressure of water passing rises due to generation of slime in an EDI device, the slime is removed by performing a cleaning process with hydrazine monohydrate and an alkali-containing agent.

Similarly to the EDI device, there is a risk of slime generation even in a reverse osmosis membrane device equipped with a reverse osmosis membrane, and a membrane such as the reverse osmosis membrane is also deteriorated by contacting with an oxidizing agent. As a slime inhibitor capable of suppressing deterioration of a reverse osmosis membrane, Patent Literature 4 discloses using a stabilized hypobromous acid composition, and Patent Literature 5 discloses using an iodine-containing oxidizing agent which contains water, iodine, and iodide.

### CITATION LIST

### Patent Literature

Patent Literature 1: JP 2018-51453 A

Patent Literature 2: JP 2000-279967 A

Patent Literature 3: JP 2004-113973 A

Patent Literature 4: JP 2015-62889 A

Patent Document 5: WO 2021/192582 A1

### SUMMARY OF INVENTION

### Technical Problem

When the slime generated in the concentration chamber of the EDI device is removed by cleaning with chemical as described in Patent Literature 3, there is a problem that the clearing process itself takes a long time, for example, several days, and the EDI device cannot be used during the cleaning process. In addition, since the liquid chemical is less likely to flow in a space blocked by slime, it is difficult to completely remove the slime in the space. When water containing a slime inhibitor that is an oxidizing agent is passed through an EDI device, blockage due to slime can be prevented. However, when the slime inhibitor is supplied to the EDI device as described in Patent Literature 1, voltage application to the EDI device must be stooped or reduced, and during that time, the deionization treatment with respect to water to be treated cannot be performed in the EDI device.

An object of the present invention is to provide a water treatment method and device using an EDI device, in which the EDI device can be operated without causing a decrease in quality of the treated water and an increase in the differential pressure of water passing in the EDI device.

Another object of the present invention is to provide a slime inhibitor that can be used in an EDI device during operation without causing a decrease in quality of the treated water and an increase in the differential pressure of water passing in the EDI device, and a method for cleaning the EDI device.

### Solution to Problem

The water treatment method according to one aspect of the present invention includes: an addition step of adding a chemical to water to be treated to obtain water to be treated which contains iodine and is provided with oxidizing power; and a treatment step of supplying the water to be treated that has undergone the addition step to an EDI device (electrodeionization device) to treat the water to be treated in the EDI device, wherein at least a part of an ion exchanger filled in a deionization chamber of the EDI device is an anion exchanger. The chemical added in the addition step is, for example, an iodine-containing oxidizing agent. However, when the water to be treated already contains an oxidizing agent, the chemical may be an iodide, and when the water to be treated already contains an iodide, the chemical may be an oxidizing agent.

The water treatment device according to one aspect of the present invention is equipped with: an addition means for adding a chemical to water to be treated to form water to be treated which contains iodine and is provided with oxidizing power; and an EDI device in which at least a part of an ion exchanger filled in a deionization chamber is an anion exchanger, wherein the water to be treated to which the chemical has been added by the addition means is supplied to the EDI device. The chemical added by the adding means is, for example, an iodine-containing oxidizing agent. However, when the water to be treated already contains an oxidizing agent, the chemical may be an iodide, and when the water to be treated already contains an iodide, the chemical may be an oxidizing agent.

The slime inhibitor according to one aspect of the present invention includes an iodine-containing oxidizing agent and is used for an EDI device.

In the cleaning method according to one aspect of the present invention, a cleaning liquid containing a slime inhibitor according to the present invention is passed through an EDI device to clean the EDI device.

### Advantageous Effect of Invention

According to the present invention, it is possible to operate an EDI device without causing a decrease in the quality of the treated water and an increase in the differential pressure of water passing in the EDI device.

### BRIEF DESCRIPTION OF DRAWINGS

FIG. 1 is a diagram showing a water treatment apparatus according to an embodiment of the present invention;

FIG. 2 is a diagram showing an example of a configuration of an EDI device;

FIG. 3 is a diagram showing another configuration example of the water treatment apparatus:

FIG. 4 is a diagram showing yet another configuration example of the water treatment apparatus;

FIG. 5 is a diagram showing another example of the configuration of the EDI device;

FIG. 6 is a graph showing a change in specific resistance of the treated water in Example 1;

FIG. 7 is a graph showing a change in the differential pressure of water passing in the deionization chamber in Example 1;

FIG. 8 is a graph showing a change in the differential pressure of water passing in the concentration chamber in Example 1; and

FIG. 9 is a graph showing a change in the effective iodine concentration in the concentrated water in Example 3.

### DESCRIPTION OF EMBODIMENTS

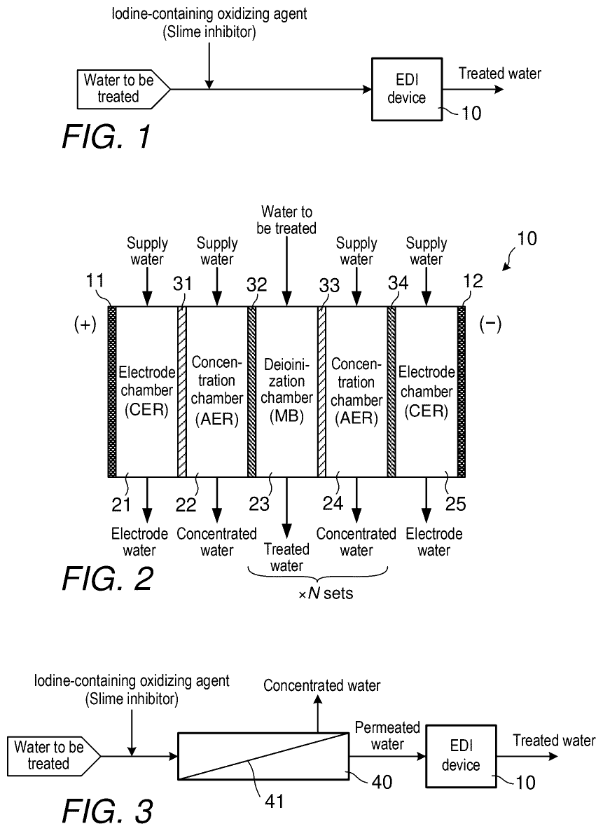

Next, preferred embodiments of the present invention will be described with reference to the drawings. FIG. 1 is a diagram showing a configuration of a water treatment apparatus according to an embodiment of the present invention. The water treatment apparatus shown in FIG. 1 is equipped with an electrodeionization device (EDI device) 10, and water to be treated is passed through EDI device 10. EDI device 10 performs, for example, deionization treatment on the supplied water to be treated, and discharges treated water. The water treatment apparatus further includes a mechanism for adding an iodine-containing oxidizing agent as a slime inhibitor to the water to be treated supplied to EDI device 10. Details of the iodine-containing oxidizing agent used as a slime inhibitor will be described later.

FIG. 2 illustrates an example of the configuration of EDI device 10. EDI device 10 is equipped with deionization chamber 23 arranged between anode chamber 21 provided with anode 11 and cathode chamber 25 provided with cathode 12. Concentration chamber 22 is disposed on a side facing anode chamber 21 of deionization chamber 23, and concentration chamber 24 is disposed on a side facing cathode chamber 25 of deionization chamber 23. Anode chamber 21 and concentration chamber 22 are partitioned by cation exchange membrane 31, and concentration chamber 22 and deionization chamber 23 are partitioned by anion exchange membrane 32. Deionization chamber 23 and concentration chamber 24 are partitioned by cation exchange membrane 33, and concentration chamber 24 and cathode chamber 25 are partitioned by anion exchange membrane 34. Therefore, deionization chamber 23 is partitioned by anion exchange membrane 32 located on the side to anode 11 and cation exchange membrane 33 located on the side to cathode 12. An ion exchange resin is filled in deionization chamber 23. In the illustrated example, an anion exchange resin (AER) and a cation exchange resin (CER) are filled in a mixed bed manner (MB). Anode chamber 21 is filled with a cation exchange resin, and concentration chambers 22, 24 and cathode chamber 25 are filled with an anion exchange resin. Concentration chambers 22, 24 may be filled with an anion exchange resin (AER) and a cation exchange resin (CER) in a mixed bed manner.

Next, the operation of the water treatment apparatus shown in FIG. 1 will be described. Supply water is passed through each of anode chamber 21, concentration chambers 22, 24, and cathode chamber 25 of EDI device 10, and, in a state where a DC current is applied between anode 11 and cathode 12, the water to be treated to which the iodine-containing oxidizing agent is added is passed through deionization chamber 23. When the water to be treated is passed through deionization chamber 23, the ion components (i.e., anion and cation) in the water to be treated are adsorbed to the ion exchange resin in deionization chamber 23. At this time, in deionization chamber 23, a dissociation reaction of water shown in formula (1) occurs at the interface between different types of ion exchange substances due to a potential difference generated by the applied current, and hydrogen ion (H⁺) and hydroxide ion (OH⁻) are generated.

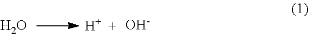

The ion components that have been adsorbed to the ion exchange resin in deionization chamber 23 are ion-exchanged and desorbed from the ion exchange resin by hydrogen ion and hydroxide ion thus generated. The anion among the desorbed ion components moves to concentration chamber 22 closer to anode 11 via anion exchange membrane 32, and is discharged as concentrated water from concentration chamber 22. Similarly, the cation moves to concentration chamber 24 closer to cathode 12 via cation exchange membrane 33, and is discharged as concentrated water from concentration chamber 24. The ion components in the water to be treated supplied to deionization chamber 23 are transferred to concentration chambers 22, 24 and discharged, and at the same time, the ion exchange resin in deionization chamber 23 is regenerated. From deionization chamber 23, the treated water in which the ion components are removed, that is, the deionized water is discharged. Electrode water is discharged from each of anode chamber 21 and cathode chamber 25. The application of the DC current may be performed continuously or intermittently when the water to be treated is passed. In order to prevent the iodine component derived from the iodine-containing oxidizing agent added to the water to be treated from leaking to the treated water, at least a part of the ion exchanger filled in deionization chamber 23 is required to be an anion exchanger, and at least a part of the ion exchanger filled in concentration chamber 24 is preferably an anion exchanger.

In EDI device 10 shown in FIG. 2, a basic configuration consisting of [concentration chamber (C) 22|anion exchange membrane (AEM) 32|deionization chamber (D) 23|cation exchange membrane (CEM) 33|concentration chamber (C) 24] is disposed between anode 11 and cathode 12. This basic configuration is referred to as a cell set. Actually, the processing capacity can be increased by juxtaposing a plurality of such cell sets between the electrodes, electrically connecting the plurality of cell sets in series, disposing anode 11 at one end of the series connection, and disposing cathode 12 at the other end. In FIG. 2, arranging a plurality of cell sets side by side is indicated as “×N sets.” In this case, since adjacent concentration chambers can be shared between adjacent cell sets, when the repeating unit composed of [AEM|D|CEM|C] is represented by X, the configuration of [anode chamber |CEM|C|X|X| . . . |X |AEM|cathode chamber] can be possible as the configuration of EDI device 10. In such a series structure, regarding deionization chamber 23 closest to anode chamber 21, anode chamber 21 itself can be functioned as concentration chamber 22 without interposing independent concentration chamber 22 between anode chamber 21 and deionization chamber 23. Similarly, with respect to deionization chamber 23 closest to cathode chamber 25, cathode chamber 25 itself can be functioned as concentration chamber 24 without interposing independent concentration chamber 24 between cathode chamber 25 and deionization chamber 23.

Next, the iodine-containing oxidizing agent to be added to the water to be treated will be described. EDI device 10 generally has a configuration in which water to be treated is passed at a large flow rate in a space filled with an ion exchanger such as a granular ion exchange resin, but a slime derived from viable bacteria may occur even in such EDI devices. In the EDI device, blockage is likely to occur when slime occurs, and due to the slime, a rise in the differential pressure of water passing and a decrease in performance due to uneven water flow tend to progress easily. In order to suppress generation of slime, it is generally effective to flow an oxidizing sterilizer as a slime inhibitor (that is, a slime control agent). However, the oxidizing sterilizer is just an oxidizing agent, and the oxidizing agent generally deteriorates the ion exchange resin and the ion exchange membrane constituting the EDI device. Therefore, conventionally, supplying EDI devices, in particular, EDI devices during operation by application of a DC current, with water containing an oxidizing agent must be avoided.

The present inventors studied measures to achieve both suppression of the occurrence of slime in an EDI device and suppression of deterioration of an ion exchange resin and an ion exchange membrane in the EDI device, and found that deterioration of performance in an EDI device can be suppressed by using an iodine-containing oxidizing agent as a slime inhibitor, and then completed the present invention. As will be apparent from Examples described later, when hypochlorous acid or hypochlorite commonly used as a slime inhibitor was added to the water to be treated to operate the EDI device, the water quality of the treated water discharged from the EDI device was deteriorated early. The worsening of the water quality is considered to be caused by deterioration of the ion exchange membrane and the ion exchange resin. But when an iodine-containing oxidizing agent was used, the water quality of the treated water from the EDI device was satisfactorily maintained over a long period of time.

In the present invention, the iodine-containing oxidizing agent is an oxidizing agent containing iodine as an element. The iodine-containing oxidizing agent may be an iodine compound that itself functions as an oxidizing agent, or may be a reactant of an iodine compound and an oxidizing agent. Since the simple substance of iodine (i.e., I₂) also has an oxidizing power, the solution containing iodine alone is also included in the scope of the iodine-containing oxidizing agent. Iodine contained in the iodine-containing oxide may be any form, and may be any one of, for example, molecular iodine; iodide; polyiodide; iodic acid; hypoiodous acid; hydrogen iodide; and iodine coordinating to organic solvent such as polyvinylpyrrolidone, cyclodextrin, or the like, and these forms may be combined. A method for dissolving single substance of iodine in a nonpolar solvent such as benzene or carbon tetrachloride, or alcohols; a method for dissolving single substance of iodine using an alkali agent and water; or a method for dissolving single substance of iodine using an iodide and water can be used as a method for obtaining iodine in one of these forms. Total iodine may be obtained by adding an acid or an oxidizing agent to a solution containing at least one of iodide and iodide ions. In addition, iodine coordinated to an organic solvent such as polyvinylpyrrolidone or cyclodextrin may be obtained by using povidone iodine in which iodine is coordinated to polyvinylpyrrolidone, iodine inclusion cyclodextrin in which iodine is included in cyclodextrin, or iodophor in which iodine is supported by an organic polymer, a surfactant agent or the like.

From the viewpoint of ease of handling and small influence on water quality of the water to be treated and the treated water, the iodine-containing oxidizing agent is preferably one obtained by dissolving simple substance of iodine by using an iodide and water without using an organic substance, that is, a solution containing water, iodine, and iodide. Simple substance of iodine alone has a low solubility in water, but is dissolved in water under coexistence of iodide or iodide ions. In the solution in which simple substance of iodine is dissolved by using the iodide and water, a stable one-component oxidizing agent in which the iodine concentration is relatively high, and handling of it is easy. Note that the iodide refers to an iodine compound having an oxidation number of −1. Examples of iodide include potassium iodide, sodium iodide, lithium iodide, hydrogen iodide, silver iodide, copper iodide, zinc iodide, and the like. These iodides are dissolved in water and dissociated to give iodide ions.

In the case of obtaining an iodine-containing oxidizing agent that is a reactant of an iodine compound and an oxidizing agent, for example, potassium iodide, sodium iodide, lithium iodide, hydrogen iodide, silver iodide, copper iodide, zinc iodide, or the like may be used as the iodine compound, and two or more of these may be used at the same time. In this case, it is preferable to use sodium iodide or potassium iodide from the viewpoint of cost, etc. As the oxidizing agent that reacts with the iodine compound, an oxidizing agent having a higher oxidation-reduction potential (ORP) than iodine is preferably used. Examples of the oxidizing agent that can be used include combined chlorine, a stabilized hypobromous acid composition, and the like. An oxidizing agent in the form which can be detected as free chlorine is preferable from the viewpoint of the speed of reaction or the like. Typical examples of the oxidizing agent in the form which can be detected as free chlorine include hypochlorous acid, hypobromous acid, and the salts thereof. The stabilized hypobromous acid composition is a reaction product of a bromine-based oxidizing agent and a sulfamic acid compound, or a product obtained by further reacting a sulfamic acid compound with a reaction product of a bromine compound and a chlorine-based oxidizing agent. Here, examples of the bromine-based oxidizing agent include simple substance of bromine, bromine chloride, bromic acid, bromate, and the like.

When the iodine-containing oxidizing agent is a solution containing water, iodine, and iodide, the molar ratio of iodide to iodine is preferably 1 or more from the viewpoint of solubility of iodine with respect to water, and from the viewpoint of stability, the pH of the solution is preferably 3 or more and 9 or less, more preferably 3 or more and 7 or less, and further preferably 4 or more and 6.5 or less. If the pH is less than 3, crystal of iodine may be precipitated, and if more than 9, the active ingredient may be significantly reduced. When the transportation cost of the slime inhibitor is taken into consideration, since it is preferable that the active ingredient has a high concentration and is stable, the total iodine concentration in the iodine-containing oxidizing agent is preferably 3 mass % or more, more preferably 3 mass % or more and 40 mass % or less, and further preferably 10 mass % or more and 25 mass % or less. The total iodine concentration here is the concentration calculated based on the total chlorine concentration regardless of whether it is an iodide or simple substance of iodine.

Although the iodine-containing oxidizing agent described above is used as a slime inhibitor for EDI device 10, the iodine-containing oxidizing agent can also be used for cleaning each of the chambers (anode chamber 21, concentration chambers 22, 24, deionization chamber 23, and cathode chamber 25) of EDI device 10. When performing cleaning of EDI device 10, the iodine-containing oxidizing agent may be dissolved in pure water to prepare cleaning liquid, and the cleaning liquid may be passed through each chamber of EDI device 10 in a state in which the operation of EDI device 10 is stopped.

In the case of managing the concentration of the iodine-containing oxidizing agent in the water to be treated, various quantification methods related to iodine can be used. In particular, when the iodine-containing oxidizing agent is a solution containing water, iodine, and iodide, iodine that is not iodide is effective iodine as an oxidizing agent. This effective iodine shows the same color reaction as residual chlorine when measuring total chlorine (or total residual chlorine) in water by a DPD method, that is, colorimetric method using DPD (N,N-diethylparaphenylene diamine). Therefore, measurement is performed using the total chlorine concentration meter by the DPD method on the premise that no residual chlorine is present, and the concentration of iodine effective as an oxidizing agent can be managed by using the measurement value. Effective iodine concentration can be also managed by using a residual chlorine quantification method or a total chlorine quantification method other than the DPD method. For example, as a method of quantifying residual chlorine, there is known a method of quantifying, by redox titration with sodium thiosulfate, iodine that is liberated from oxidation of potassium iodide by residual chlorine. By applying this method and performing the redox titration with sodium thiosulfate on the water to be treated, the effective iodine concentration in the water to be treated can be obtained as a value converted into the total chlorine concentration. In the following description, when referred to is not total iodine concentration but effective iodine concentration, the effective iodine concentration may be expressed as total chlorine concentration converted value. The total chlorine concentration converted value is a measurement value obtained as a total chlorine concentration when measuring the effective iodine concentration using a method used for measuring the total chlorine concentration, and is a value obtained by converting the effective iodine concentration into the total chlorine concentration. When the effective iodine concentration is represented by the total chlorine concentration converted value, “as Cl₂” is added to explicitly indicate that.

The concentration of the iodine-containing oxidizing agent when added to the water to be treated needs to be such that it has sufficient sterilization capability. From such a viewpoint, when the iodine-containing oxidizing agent is added to the water to be treated, it is preferable that the iodine concentration effective as an oxidizing agent in the water to be treated supplied to EDI device 10 is 0.05 mg/L as Cl₂ or more. Even if the influence of the iodine-containing oxidizing agent on the EDI device is slight as compared with hypochlorous acid or the like, if the concentration of the iodine-containing oxidizing agent is excessively high, there is a risk that the EDI device deteriorates. Therefore, it is preferable that the effective iodine concentration in the water to be treated supplied to EDI device 10 is less than 10.0 mg/L as Cl₂.

The addition of the iodine-containing oxidizing agent to the water to be treated may be performed continuously or intermittently. In order to suppress the occurrence of slime, the amount of the iodine-containing oxidizing agent added may be large, but it is not necessary to continuously add the iodine-containing oxidizing agent to the water to be treated, and the iodine-containing oxidizing agent can be intermittently added to the water to be treated. By intermittently adding the iodine-containing oxidizing agent, deterioration of EDI device 10 can be further suppressed. When the deionization treatment on the water to be treated is continuously performed, a period of adding the iodine-containing oxidizing agent to the water to be treated is defined as an addition period, and a period in which addition is not performed is defined as an addition-free period, it is possible to add the iodine-containing oxidizing agent to the water to be treated with the addition period within a range of 10 seconds to 12 hours and the addition-free period within a range of 5 seconds to 320 hours so that the addition period does not exceed 12 hours within any 24 hours. When the iodine-containing oxidizing agent is intermittently added to the water to be treated, it is not appropriate to evaluate the influence of the iodine-containing oxidizing agent on EDI device 10 only based on the oxidizing agent concentration in the water to be treated during the addition of the iodine-containing oxidizing agent. Therefore, when the converted value to the total chlorine concentration of the iodine concentration effective as an oxidizing agent in the water to be treated during the addition of the iodine-containing oxidizing agent to the water to be treated is represent by C, it is preferable to calculate an integrated amount of concentration C in the period T in which addition of the iodine-containing oxidizing agent to the water to be treated is performed, that is, a CT value, and use the CT value as an index for management.

In the above description, the water to be treated to which the iodine-containing oxidizing agent has been added is passed through deionization chamber 23 of EDI device 10. But the water to be treated to which the iodine-containing oxidant has been added may be further supplied to concentration chambers 22, 24 and the electrode chamber. Anode chamber 21 and cathode chamber 25 are collectively referred to as an electrode chamber. Although the supply water passing through concentration chambers 22, 24 and the electrode chamber is not particularly limited, ion concentration is easy to increase in concentration chambers 22, 24, and therefore viable bacteria are easy to propagate and slime tends to occur in concentration chambers 22, 24. Even in the electrode chamber, viable bacteria may propagate to generate slime depending on the type of the supply water. Therefore, by continuously or intermittently using the water to which the iodine-containing oxidizing agent is added as the supply water for concentration chambers 22, 24 and the electrode chambers, the generation of slime or the like in concentration chambers 22 and 24 and the electrode chambers can be suppressed.

In the present embodiment, as an oxidizing agent used as a slime inhibitor in an EDI device, an iodine-containing oxidizing agent is used instead of a chlorine-based oxidizing agent such as hypochlorous acid or hypochlorite, so that the EDI device can be continuously operated to obtain a sufficient bactericidal effect while preventing deterioration of the EDI device, without providing a means for removing oxidizing agent in a preceding stage of the EDI device or performing halt control of the EDI device.

In a water treatment apparatus provided with an EDI device, there are few examples in which the EDI device is used alone, and a membrane device with a separation membrane is often provided in a preceding stage of the EDI device to supply the EDI device with the water to be treated that has permeated the separation membrane. FIG. 3 illustrates a water treatment apparatus configured such that, in the water treatment apparatus shown in FIG. 1, reverse osmosis membrane device 40 provided with reverse osmosis membrane 41, which is a separation membrane, is provided in the preceding stage of EDI device 10. In the water treatment apparatus shown in FIG. 3, the water to be treated is first supplied to reverse osmosis membrane device 40. The permeated water passing through reverse osmosis membrane 41 of reverse osmosis membrane device 40 is supplied to deionization chamber 23 of EDI devices 10 as the water to be treated in EDI device 10. The permeated water from reverse osmosis membrane device 40 may be supplied to concentration chambers 22, 24 and the electrode chamber of EDI device 10. The water to be treated that has not passed through reverse osmosis membrane 41 is discharged as concentrated water from reverse osmosis membrane device 40. In the water treatment apparatus shown in FIG. 3, a mechanism for adding an iodine-containing oxidizing agent that is a slime inhibitor to the water to be treated is provided in the preceding stage of reverse osmosis membrane device 40. In the water treatment apparatus shown in FIG. 3, since the iodine-containing oxidizing agent is added to the water to be treated in the preceding stage of reverse osmosis membrane device 40, adhesion of slime to reverse osmosis membrane 41 can be also suppressed.

Since various organic substances and the like are removed in reverse osmosis membrane device 40, the impurity concentration in the water to be treated that permeates reverse osmosis membrane device 40 to be supplied to EDI device 10 is lower than the impurity concentration in the water to be treated supplied to EDI device 10 in the water treatment apparatus shown in FIG. 1. Therefore, in the water treatment apparatus shown in FIG. 3, the generation of slime in EDI device 10 is less likely to occur in comparison with the water treatment apparatus shown in FIG. 1. Thus, when reverse osmosis membrane device 40 is provided in the preceding stage of EDI device 10, the iodine concentration effective as an oxidizing agent in the water to be treated at the inlet of EDI device 10 can be made lower than the concentration in the water treatment apparatus shown in FIG. 1.

As the separation membrane provided in the preceding stage of EDI device 10, for example, a nanofiltration membrane (NF membrane), an ultrafiltration membrane (UF membrane), a precision filtration membrane (MF membrane), a forward osmosis membrane (FO membrane), and the like can be used in addition to reverse osmosis membrane 41 in the example shown in FIG. 3, and these membranes can also be combined. The water to be treated that has permeated the separation membrane is supplied to EDI device 10. In order to suppress the occurrence of slime in these separation membranes, it is preferable to add the iodine-containing oxidizing agent to the water to be treated at the preceding stage of the separation membrane.

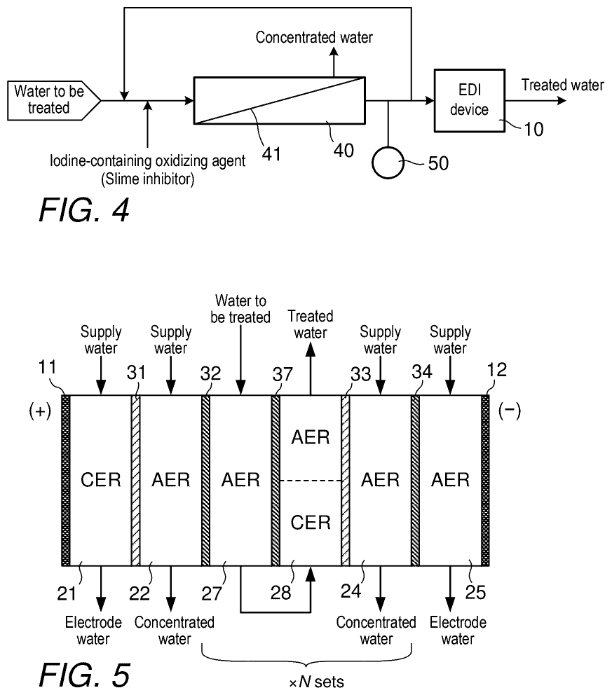

FIG. 4 shows a configuration of another water treatment apparatus according to the present invention. The water treatment apparatus shown in FIG. 4 is configured such that, in the water treatment apparatus shown in FIG. 3, total chlorine concentration meter 50 by the DPD method connected to the permeated water outlet of reverse osmosis membrane device 40 and a pipe for returning the permeated water of reverse osmosis membrane apparatus 40 to the preceding stage of reverse osmosis membrane device 40 are provided. Total chlorine concentration meter 50 is provided to determine the concentration of the iodine-containing oxidizing agent, in particular, the effective iodine concentration, in the permeated water of reverse osmosis membrane device 40. In this water treatment apparatus, in order to reduce the effective concentration of iodine, which is an oxidizing agent, in the water to be treated supplied to EDI device 10 at the subsequent stage, control is performed so that the effective iodine concentration measured as the residual chlorine concentration by total chlorine concentration meter 50 is less than a predetermined value. In order to reduce the effective iodine concentration in the permeated water, the concentration of the oxidizing agent in the water to be treated supplied to EDI device 10 may be adjusted based on the measured value of total chlorine concentration meter 50 by, for example, controlling the additive amount of the iodine-containing oxidizing agent, or by increasing or decreasing the amount of the permeated water returned when the permeated water discharged from reverse osmosis membrane device 40 is returned to the preceding stage side of reverse osmosis membrane device 40, or by providing an activated carbon device to the permeated water outlet of reverse osmosis membrane device 40.

The water treatment apparatuses shown in FIGS. 3 and 4 are configured such that reverse osmosis membrane device 40 is disposed at a preceding stage of EDI device 10, and the iodine-containing oxidizing agent is added to the water to be treated supplied to reverse osmosis membrane device 40. In these water treatment devices, the iodine-containing oxidizing agent may be added to the water to be treated continuously or intermittently. In order to suppress the deterioration of reverse osmosis membrane 41 and EDI device 10 while suppressing the occurrence of slime and in order to suppress the deterioration of the water quality in the treated water, it is preferable to intermittently add the iodine-containing oxidizing agent also when the iodine-containing oxidizing agent is added to the water to be treated in the preceding stage of reverse osmosis membrane device 40. As the water to be treated is continuously supplied to the water treatment treatment, for example, it is possible to add the iodine-containing oxidizing agent to the water to be treated, which is supplied to reverse osmosis membrane device 40, with, for example, the addition period within a range of 10 seconds to 12 hours and the addition-free period within a range of 5 seconds to 320 hours so that the addition period does not exceed 12 hours within any 24 hours.

FIG. 5 shows another example of an EDI device that can be used in each of the water treatment apparatuses shown in FIGS. 1, 3 and 4. The EDI device shown in FIG. 5 is obtained by dividing deionization chamber 23 of EDI device 10 shown in FIG. 2 by an intermediate ion exchange membrane, and the side to anode 11 of deionization chamber 23 from the intermediate ion exchange membrane is defined as first small deionization chamber 27, and the side to cathode 12 from the intermediate ion exchange membrane as second small deionization chamber 28. Anion exchange membrane 37 is used as the intermediate ion exchange membrane. Therefore, first small deionization chamber 27 is partitioned by anion exchange membrane 32 and anion exchange membrane 37, and second small deionization chamber 28 is partitioned by anion exchange membrane 37 and cation exchange membrane 33. In this EDI device, the water to be treated is first supplied to first small deionization chamber 27, the outlet water of first small deionization chamber 27 is supplied to second small deionization chamber 28 as it is, and the treated water of the EDI device is discharged from second small deionization chamber 28. In the example shown here, first small deionization chamber 27 is filled with an anion exchange resin. Second small deionization chamber 28 has a multiple bed structure, the upstream side of second small deionization chamber 28 is filled with a cation exchange resin along the direction of the flow of the water to be treated, and the downstream side is filled with an anion exchange resin. Also in the EDI device shown in FIG. 5, a plurality of repeating units X can be set in series between concentration chamber 22 adjacent to anode chamber 21 and anion exchange membrane 34 in contact with cathode chamber 25, with the arrangement consisting of anion exchange membrane 32, first small deionization chamber 27, anion exchange membrane 37, second small deionization chamber 28, cation exchange membrane 33, and concentration chamber 24 as the repeating unit X.

As described above, the iodine-containing oxidizing agent used in the present embodiment is an oxidizing agent containing iodine as an element, and the water to be treated comes to have an oxidizing power by addition of the iodine-containing oxidizing agent. Therefore, when the water to be treated itself contains an oxidizing agent and has an oxidizing power, only by adding an iodide to the water to be treated, the water to be treated is in the same state as that when the iodine-containing oxidizing agent is added. Similarly, when the water to be treated itself already contains an iodide, only by adding an oxidizing agent to the water to be treated, the water to be treated is in the same state as that when the iodine-containing oxidizing agent is added. As a chemical is added to the water to be treated, the present invention thus covers: a case in which the chemical added to the water to be treated is an iodide when the water to be treated already contains an oxidizing agent; and a case in which the chemical added to the water to be treated is an oxidizing agent when the water to be treated already contains an iodide, in addition to the case in which the added chemical is the iodine-containing oxidizing agent. Further, also included in a scope of the present invention is a case in which an iodine-containing chemical and an oxidizing agent are separately added to the water to be treated so that an iodine-containing oxidizing agent is generated by mixing or reaction in the water to be treated.

### EXAMPLES

Next, the present invention will be described in more detail with reference to Examples and Comparative Examples. Hereinafter, the effective iodine concentration is a value obtained by performing the measurement of total chlorine concentration by the DPD method. As described above, the CT value is a value obtained as an integrated amount of effective iodine concentration C in the water to be treated during the period T in which the iodine-containing oxidizing agent is added to the water to be treated.

### Example 1

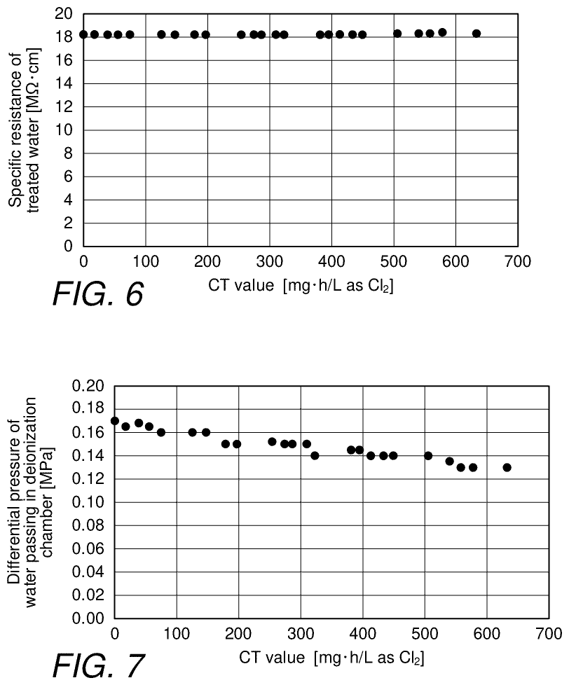

EDI device 10 shown in FIG. 5 was assembled, and this EDI device 10 was operated by supplying EDI device 10 with the water to be treated to which an iodine-containing oxidizing agent was added as a slime inhibitor. The specific resistance of the treated water discharged from second small deionization chamber 28 at that time, the change in the differential pressure of water passing in the entirety of first small deionization chamber 27 and second small deionization chamber 28, and the change in the differential pressure of water passing in concentration chambers 22, 24 were investigated. The differential pressure of water passing in the entirety of first small deionization chamber 27 and second small deionization chamber 28 is defined as the differential pressure of water passing in the deionization chamber. Water obtained by treating well water in Sagamihara City with a reverse osmosis membrane device was used as the water to be treated, and the effective iodine concentration in the water to be when adding an iodine-containing oxidizing agent was set to 0.75 mg/L as Cl₂. As the iodine-containing oxidizing agent, a solution containing water, iodine, and iodide was used. The results regarding the specific resistance of the treated water are shown in FIG. 6, the results regarding the differential pressure of water passing in the deionization chamber are shown in FIG. 7, and the results regarding the differential pressure of water passing in the concentration chambers are shown in FIG. 8. The horizontal axis in these figures is represented by the CT value.

### Comparative Examples 1 and 2

EDI device 10 shown in FIG. 5 was assembled and operated in the same manner as in Example 1, and the change in the specific resistance of the treated water was examined. However, as the slime inhibitor added to the water to be treated, sodium hypochlorite was used in Comparative Example 1, and the stabilized hypobromous acid composition was used in Comparative Example 2. Table 1 shows the specific resistance of the treated water before the start of operation and the specific resistance of the treated water at the time when the CT value reached 100 mg·h/L as Cl₂ after the start of operation, together with the results in the case of Example 1 described above.

TABLE 1

| | Exam- | Comparative | Comparative |
|---|---|---|---|
| | ple 1 | Example 1 | Example 2 |
| Slime inhibitor | Iodine- | Sodium | Stabilized |
| | containing | hypochlorite | hypobromous |
| | oxidizing | | acid |
| | agent | | composition |
| Specific resistance of treated | 18 | 18 | 18 |
| water at CT value = 0 mg · h/ | | | |
| L as Cl₂ [MΩ · cm] | | | |
| Specific resistance of treated | 18 | 3 | 14 |
| water at CT value = 100 mg · | | | |
| h/L as Cl₂ [MΩ · cm] | | | |

As shown in Example 1, when the iodine-containing oxidizing agent was used as a slime inhibitor, the specific resistance of the treated water of the EDI device was maintained at a high level over a long period, and the differential pressure of water passing in each of the deionization chamber and the concentration chamber was hardly changed. On the other hand, in each of Comparative Example 1 using sodium hypochlorite as the slime inhibitor and Comparative Example 2 using the stabilized hypobromous acid composition, the specific resistance decreases when the operation time of the EDI device became long, and the water quality of the treated water was deteriorated. In Comparative Example 1 using sodium hypochlorite, as the tendency of change in specific resistance, the specific resistance of the treated water suddenly decreased early after the start of operation of the EDI device, and thereafter the specific resistance did not change much. On the other hand, in Comparative Example 2 using the stabilized hypobromous acid composition, the specific resistance gradually decreased. From these results, it was found that, by using the iodine-containing oxidizing agent as a slime inhibitor, it is possible to suppress a decrease in the treated water quality and an increase in differential pressure of water passing in the EDI device.

### Example 2, and Comparative Examples 3 and 4

The slime inhibitor was brought into contact with water containing viable bacteria, and the number of viable bacteria before the contact with the slime inhibitor and the number of viable bacteria after contact with the slime inhibitor for one hour were examined. As the slime inhibitor, the same iodine-containing oxidizing agent as that used in Example 1 was used in Example 2, sodium hypochlorite was used in Comparative Example 3, and the stabilized hypobromous acid composition was used in Comparative Example 4. The concentration of the slime inhibitor was 0.1 mg/L as Cl₂ for each case. The results are shown in Table 2.

TABLE 2

| | | Comparative | Comparative |
|---|---|---|---|
| | Example 2 | Example 3 | Example 4 |
| Slime inhibitor | Iodine- | Sodium | Stabilized |
| | containing | hypochlorite | hypobromous |
| | oxidizing | | acid |
| | agent | | composition |
| Number of viable bacteria | 10⁷ | 10⁶ | 10⁶ |
| before contact with slime | | | |
| inhibitor | | | |
| Number of viable bacteria | Not detected | 10⁵ | 10⁵ |
| after contact with slime | | | |
| inhibitor for one hour | | | |

From the above results, it was found that the iodine-containing oxidizing agent as a slime inhibitor has a strong bactericidal power compared to sodium hypochlorite and the stabilized hypobromous acid composition. Since decrease in the treated water quality and increase in the differential pressure of water passing can be suppressed in an EDI device by using the iodine-containing oxidizing agent as a slime inhibitor as described above, it was found that the iodine-containing oxidizing agent is an excellent slime inhibitor which can be used for an EDI device in operation.

### Example 3

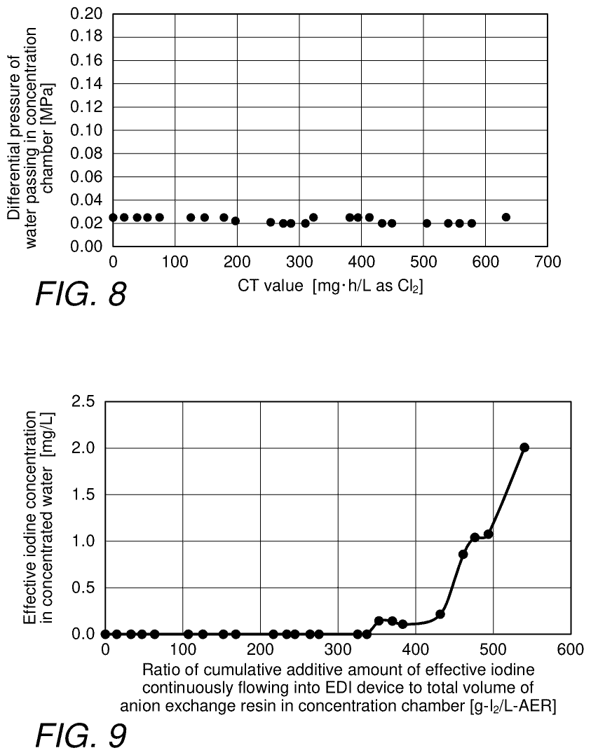

EDI device 10 shown in FIG. 5 was assembled, and the water to be treated to which the iodine-containing oxidizing agent was added as a slime inhibitor was supplied to first small deionization chamber 27, concentration chambers 22, 24 and the electrode chamber of EDI device 10 to operate EDI device 10. The relationship between the ratio of the cumulative amount of the effective iodine continuously flowing into EDI device 10 with respect to the total volume of the anion exchange resin (AER) filled in concentration chambers 22, 24 of EDI device 10 and the effective iodine concentration in the concentrated water discharged from EDI device 10 was examined. The results are shown in FIG. 9. It was found that, until the cumulative amount of the effective iodine continuously flowing into EDI device 10 reaches a certain value, the leakage of iodine components to the concentrated water flowing out from concentration chambers 22, 24 does not occur, and iodine is captured by the anion exchange resin in EDI device 10. The iodine component here includes iodide ions or the like.

### REFERENCE SIGNS LIST

10 Electrodeionization device (EDI device);
40 Reverse osmosis membrane device;
41 Reverse osmosis membrane;
50 Total chlorine concentration meter;
11 Anode;
12 Cathode;
21 Anode chamber;
22, 24 Concentration chamber;
23 Deionization chamber;
25 Cathode chamber;
27, 28 Small deionization chamber;
31, 33 Cation exchange membrane; and
32, 34, 37 Anion exchange membrane.

1. A water treatment method comprising:
adding a chemical to water to be treated to obtain water to be treated which contains iodine and is provided with oxidizing power; and
supplying the water to be treated that has undergone the chemical addition to an electrodeionization device to treat the water to be treated in the electrodeionization device,
wherein at least a part of an ion exchanger filled in a deionization chamber of the electrodeionization device is an anion exchanger.

2. The water treatment method according to claim 1, wherein, during the treatment of the water in the electrodeionization device, the water to be treated that has undergone the chemical addition is treated with a separation membrane before the water to be treated that has undergone the chemical addition is supplied to the electrodeionization device.

3. The water treatment method according to claim 1, wherein the chemical is a solution containing water, iodine, and iodide.

4. A water treatment apparatus comprising:
an addition means for adding a chemical to water to be treated to form water to be treated which contains iodine and is provides with oxidizing power; and
an electrodeionization device in which at least a part of an ion exchanger filled in a deionization chamber is an anion exchanger,
wherein the water to be treated to which the chemical has been added by the addition means is supplied to the electrodeionization device.

5. The water treatment apparatus according to claim 4,
wherein a separation membrane is provided at a position that is a subsequent stage of the addition means and is a preceding stage of the electrodeionization device, and
wherein the water to be treated to which the chemical has been added is supplied to the electrodeionization device after being treated by the separation membrane.

6. The water treatment apparatus according to claim 4, wherein the chemical is a solution containing water, iodine, and iodide.

7. The water treatment apparatus according to claim 4, wherein at least a part of an ion exchanger filled in a concentration chamber of the electrodeionization device is an anion exchanger.

8. A slime inhibitor comprising an iodine-containing oxidizing agent,
wherein the slime inhibitor is used for an electrodeionization device.

9. The slime inhibitor according to claim 8, wherein the slime inhibitor is a solution containing water, iodine, and iodide.

10. A cleaning method comprising passing a cleaning liquid containing the slime inhibitor according to claim 8 through an electrodeionization device to clean the electrodeionization device.
